(19) United States
(12) Patent Application Publication
(10) Pub. No.: US 2016/0260038 A1
(43) Pub. Date: Sep. 8, 2016

(54) SYSTEM, DEVICES AND PROCESS FOR ENTRY INTO THE MUSICAL INDUSTRY

(71) Applicant: Naheem Houston, St. Louis, MO (US)

(72) Inventor: Naheem Houston, St. Louis, MO (US)

(21) Appl. No.: 15/058,733

(22) Filed: Mar. 2, 2016

Related U.S. Application Data
(60) Provisional application No. 62/126,901, filed on Mar. 2, 2015.

(51) Int. Cl. G06Q 10/06

(52) U.S. Cl. CPC G06Q 10/0637

(57) ABSTRACT

The present invention provides a system and device utilizing software-facilitated, and machine- or internet-implemented tools to enable a quantifiable and ordered procedure for guiding aspiring music industry participants into the music industry and accounting for contingencies that may arise, which transforms the process into a multi-step operation so that the aspiring participant receives a quantifiable game plan.

### CROSS-REFERENCE TO RELATED APPLICATIONS

This application claims priority to U.S. provisional application No. 62/126,901, filed on Mar. 2, 2015, which is incorporated herein by reference as though fully set forth herein.

### STATEMENT REGARDING FEDERALLY SPONSORED RESEARCH OR DEVELOPMENT

Not applicable.

### BACKGROUND

The present invention relates to systems, devices and processes which provide an aspiring musician and other musical industry entrant desiring to enter the music industry with a seven-step operation to do so, generating tangible products specifically directed toward that purpose.

There are many talented musicians and others with a strong interest in entering the music industry. However, there are many roadblocks and unmet needs which make this journey a quite difficult one that too few successfully complete. Current resources for aspirants in the musical industry lack clear quantifiable tools and are highly subjective, and generally lack sufficient focus. A system, device and process for uncovering the aspirant's needs and providing them with specific quantifiable, concrete steps, tools and useful products tailored to the specific aspirant for overcoming these roadblocks would provide a significant benefit to those seeking to obtain these goals.

### SUMMARY OF THE INVENTION

The present invention provides a system utilizing tools to enable an ordered procedure for guiding aspiring musical performers and others into the music industry and accounting for contingencies that may arise. This novel system transforms the process into a seven-step operation so that the aspiring performer or other industry entrant receives tangible products such as a budget, a kit, a written goal-driven and stepwise plan and other tools unique to their circumstances.

The system, optionally, may be for use in a machine or combination of machines, or it may also be internet-based. The machine or machines or internet-based system employed may perform calculations required by the ordered procedure and transmit transactional data to one or more information technology repositories of the system operator. A software program may be installed on the machine or machines, or an internet-based system may be utilized for the calculation and transmission purposes outlined above. Where the coding of the software program or internet system relies on an algorithm, such as in both human languages and computer languages that optimizes tangible products such as a musician's entrepreneurial or other kit, an expected timeline and/or budget for the aspiring musician, it takes into account such variables as the aspiring musicians resources and prior steps into the music industry. The system operator running such operations connects the machine or machines, or internet system as described with the information technology repositories of the system so that the budget, written game plan and other tools and products can be transmitted to the aspiring musician. In preferred embodiments, a display, such as an internet webpage portal or written download, may be provided on which at least the written game plan, kit and budget are presented for viewing. The display may have a connection with a data processor by which the budget, kit and other tools and products are configured and are transmitted to the display for viewing. More preferably, at least the game plan, kit and suggested timeline may also be displayed. The display also may be included in a device such as a hand-held device using, e.g., a mobile cell phone application, to conveniently present one or more of the timeline, budget, game plan and other tools of the kit useful for entry into the music entry to the user for use, download and printing.

In a preferred embodiment, a seven-step or similar such operation includes at least many of the following steps, or ones of similar import, of evaluating categories of entrepreneurship, advising, production, intellectual property and royalties assessment, website and social program development, and determining the marketing and distribution product needs and/or opportunities of the aspiring music industry entrant.

The evaluation of the relevant categories may include having the aspiring musician or other entrant answer a series of yes and no questions from which a customized strategy for a timeline, overview, budget and portfolio can be provided. One advantage of the system, is it provides a way for the aspirant to make needed decisions based on criteria not readily understood or quantified by prior art “discussion”-related advisory consultations. More preferably, the process includes a seven-step evaluation that is broken down into detailed questions such as set forth in Example 1, wherein needs and “take home” products and services such as a “business model plan” and a webpage or music video are analyzed and evaluated. The system may include alternative software programs or internet systems that serve the purpose of evaluation, needs assessment, calculation, the purpose of transmission, and combinations thereof. As a component, the aspiring musician is provided the ability to upload music samples and bios as part of the system and method, to create components for his or her portfolio or as part of his kit, produced by the system and method described herein.

Alternative algorithms and needs systems using different optimization techniques for expected optimization of the aspiring musician's or other entrant's game plan, budget and other tools, in such a kit or product and/or different connection pathways for transmission of music, bios, transactional data for accounting, marketing or other business operations may be provided without departing from the system, devices and processes of this invention.

Accordingly, in one aspect of the invention, a system to assist an aspiring musical industry aspirant gain entrance into the musical industry is provided. The system includes machine-readable software for providing an ordered procedure for guiding an aspiring music industry participant into the music industry and accounting for contingencies that may arise, which transforms the process into a multi-step operation so that the aspiring participant receives as a product at least a quantifiable game plan and budget and may include other quantified recommendations for entry into the musical industry. The system includes the use of the machine, combination of machines, or internet interface, for conducting calculations required by the ordered procedure described above and for transmitting transactional data to one or more information technology repositories of the system operator. The system further includes a software program installed onto the machine, machines or internet interface for the calculation and transmission purposes; and for optimization of the game plan and budget for the aspiring musical industry participant by which the system operator running such operations can connect the machine, combination of machines, or internet interface with the information technology repositories of the system so that products such as the quantifiably optimized game plan and budget can be transmitted to the aspiring music industry participant for his or her use.

In another aspect, the invention includes a device which includes a display on which at least a game plan and budget devised by the above-described system comprising an ordered procedure for guiding aspiring music industry participants into the music industry and accounting for contingencies that may arise, employing a multi-step, quantifiable operation so that the aspiring participant receives at least a game plan and budget are presented for viewing. The display of the device is connected to a data processor by which the calculated game plan and budget are transmitted to the display for viewing by a transmitter for sending or receiving the data to or from the device.

### BRIEF DESCRIPTION OF THE DRAWINGS

The presently disclosed subject matter will be better understood from reading the description of non-limiting embodiments, with reference to the attached drawings, wherein below:

FIG. 1 is a schematic depiction of an exemplary embodiment of the invention system flow chart and pathway for an aspiring musician, according to the invention.

### DETAILED DESCRIPTION OF THE INVENTION

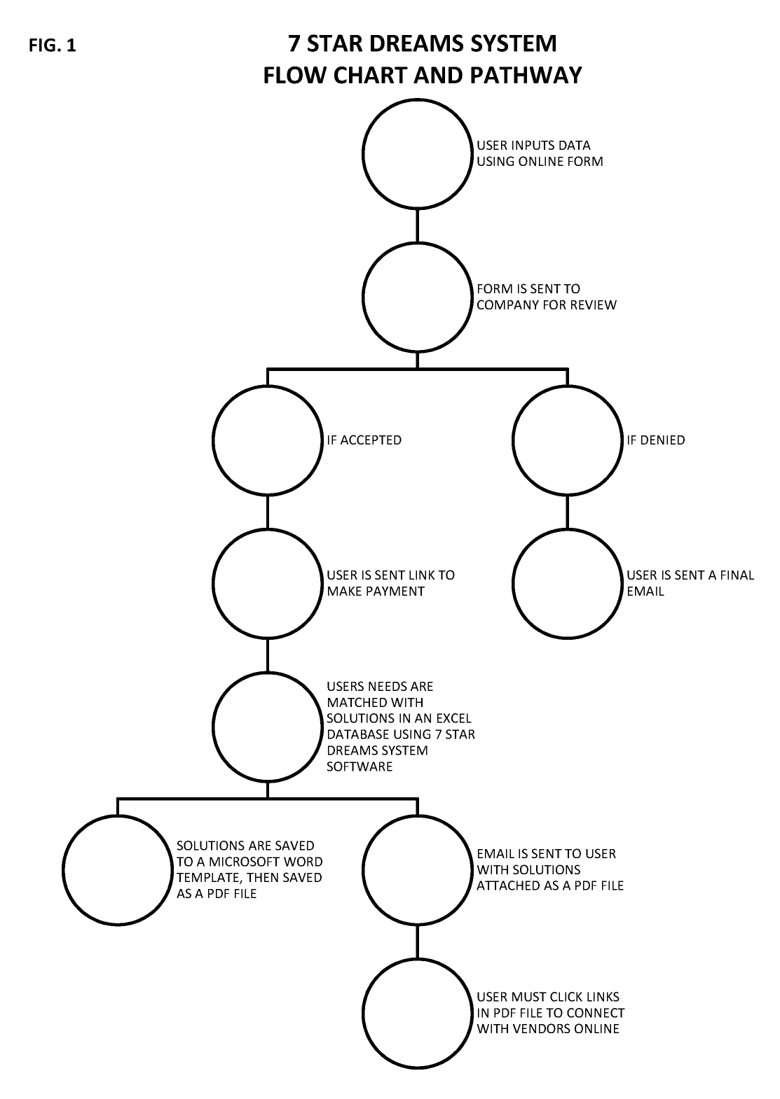

FIG. 1 shows an exemplary system laying out schematically steps and components of the system to provide an ordered procedure for music industry aspirants to receive quantifiable guidance and concrete steps to enter into the music industry, whether, e.g., as a vocal or instrumental performer, as a band or other group, or, e.g., by providing support or service to the music industry. Examples of these include sound recording, composition writing, and musical broadcasting technicians.

The systems, methods and related devices, tools and products of the invention are best shown by the following examples:

### EXAMPLE 1

The system of the invention has a number of basic features, and optionally also provides for landing pages and an account page:
1. Overview—Allows the user to upload contact information such as Name, Email, Phone Number, Genre of music, Song Title, Link to song (if available online), location, and to insert information about themselves in a biography format.
2. Questionnaire—A 7 Step System Questionnaire includes a series of music-related questions organized in 7 different categories: Entrepreneurship, Advising, Production, Intellectual Property & Royalties, Website & Social Media, Distribution, and Marketing, which are used to help uncover the user's problems, issues and concrete and quantifiable steps that can be taken to achieve the user's goals in the music industry.
3. My Budget—A user enters information pertaining to his or her income, expenses, and relevant pay dates. An algorithm tied to translating these into a workable budget is generated, which is also based on their needs as expressed in response to the questionnaire.

The software will use the following formula in order to calculate the aspiring musician's net income:
About how much do you make per month? The dollar amount of how much you make per month×12 months=gross income. Ex: $1,000—12 months=$1,200, which is the gross income.
How much do you spend on bills each month? The dollar amount will be subtracted from the user's gross income over 12 months. This will provide the user's net income. The net income will be shown on the user's budget.
When is your next pay date? This information will be used in the algorithm to determine the users projected “day of completion.”
4. My Timeline—Based on how a user of the questionnaire has answered the questionnaire, e.g., with “Yes” and “No” answers, from the administrative end of the website, the user is assigned a customized strategy which consists of the following information:
   What to do (Ex: Distribute your single to iTunes),
   Who to contact (Ex: www.TuneCore.com),
   How much it will cost (Ex: $10).

Finally, based on the dollar amount of the total recommendations made by employing the calculations using the software inputting the user's data such as the user's net income, an algorithm tied to his or her projected accumulation of resources calculates the “number of days” it will take for the user to achieve all recommendations.

The system software is set up to provide the aspiring musician or other user with the number of days it will take him or her to reach his or her objectives (e.g. completing this program) if they a) stick to his/her budget, b) follow recommendations and c) if the relevant vendors' fees don't change too drastically. The following formula: days360 (start_date, end_date) is used in this example in order to determine this output day for the aspiring musician.

### EXAMPLE 2

### Using the System as per the Embodiment of Example 1

An aspiring musician has accumulated $758 in Vendors' Fees. Based on the aspiring musician's net income of $200 at the end of each month (the aspiring musician gets paid 2 times per month), they will have the $758 (actually $800) on 4/25/20xx which is the end date.
A. The aspiring musician's start date when they will receive their first check is 3/22/20xx. (Note: since the aspiring musician's start pay date is late in the month and he/she will only be receiving 1 check this month, this reduces the aspiring musician's net income for this month. So instead of the net income being $200 for the month, it will only be $100).
B. The end date when the aspiring musician will have accumulated the amount of money equal to or greater than the amount of Vendors' Fees needed is on Jun. 28, 20xx.
C. The days in between the aspiring musician's start date and end date is 96 days.

Process

User's Input—Answer questions to uncover problems and goals of the user, enter information for budget, and create a profile.

User's Output—Number of days to fix problems and achieve goals, vendor contact information links, vendor fees, recommendations.

How It Works

The 7 Step System

After uncovering your needs through a questionnaire and developing a budget based on your job's income (or other sources), we use our software program to provide you with a quantifiable, concretely designed game plan and budget.

This easy-to-follow strategy tells you exactly ‘what to do,’ ‘who to contact,’ ‘how much it will cost,’ and ‘how many days it will take’ for you to take care of any factors preventing you from being successful in the Music Business.

Submit Your Music Form

Below is our 7 step system using our questionnaire assessment, designed to help uncover your needs as a musician. We use this to find solutions to your needs and connect you with vendors in our network. Please be honest in your responses.

If you are a new artist that doesn't have any music to submit, skip questions 5 & 6.

### DAY OF COMPLETION

You are days away from reaching your goal, if you begin investing in your project on Feb. 19, 20xx

*This is subject to change if you don't stick to your budget, your income decreases, or if vendor's fees go up.

The foregoing description and accompanying drawings are intended to be illustrative of exemplary embodiments of the invention only and should not be construed in any manner that limits the scope of the appended claims.

Having described my invention, I claim:

1. A system, for use in a machine, combination of machines, or internet interface, comprising:
machine-readable software for providing an ordered procedure for guiding an aspiring music industry participant into the music industry and accounting for contingencies that may arise, which transforms the process into a multi-step operation so that the aspiring participant receives at least a quantifiable game plan;
a machine, combination of machines, or internet interface, for conducting calculations required by the ordered procedure and for transmitting transactional data to one or more information technology repositories of the system operator; and,
machine-readable software that optimizes the quantifiable game plan for the aspiring music industry participant based on the participant's responses which a system operator running such operations connects the machine, combination of machines, or internet interface with information technology repositories of the system so that the optimized quantifiable game plan can be transmitted to the aspiring music industry participant.

2. A system as recited in claim 1 wherein the multi-step operation includes the steps of separately evaluating categories of entrepreneurship, advising, production, intellectual property and royalties, website and social, distribution, and marketing needs of the aspiring musical performer.

3. A system as recited in claim 2 wherein the evaluation of the categories includes having the aspiring music industry participant answer a series of yes and no questions from which a customized strategy for a timeline, overview, budget and portfolio can be provided.

4. A system as recited in claim 2 wherein the evaluation of the categories includes having the aspiring musician answer a series of “need-based” questions from which a customized strategy for the quantifiable game plan can be provided.

5. A system as recited in claim 1 which includes alternative software programs that serve the purpose of calculation, the purpose of transmission, and combinations thereof.

6. A system as recited in claim 1 which includes alternative algorithms using different optimization techniques for expected optimization of the aspiring musician's quantifiable game plan and/or different connection pathways for transmission of transactional data for accounting, marketing or other business operations.

7. A system as recited in claim 1 which includes a display on which at least the quantifiable game plan is presented for viewing and having a connection between a data processor and the display by which the calculated quantifiable game plan are transmitted to the display for viewing.

8. A device comprising a display on which at least a quantifiable game plan devised by a system which comprises an ordered procedure for guiding aspiring music industry participants into the music industry and accounting for contingencies that may arise, which transforms the process into a multi-step, quantifiable operation so that the aspiring participant receives at least a quantifiable game plan presented for viewing and having a connection between a data processor and the display by which the calculated quantifiable game plan can be transmitted to the display for viewing, and also comprises a transmitter for sending or receiving the data.

9. Claim 8 wherein the device comprises a hand-held or mobile device.

10. Claim 8 wherein the device comprises an Internet server or adjunct thereof.
